(19) United States
(12) Patent Application Publication
(10) Pub. No.: US 2024/0218977 A1
(43) Pub. Date: Jul. 4, 2024

(54) DEVICE FOR STORING AND SUPPLYING CRYOGENIC FLUID, VEHICLE AND CORRESPONDING METHOD

(71) Applicant: L'Air Liquide, Societe Anonyme pour l'Etude et l’Exploitation des Procedes Georges Claude, PARIS (FR)

(72) Inventors: Laurent ALLIDIERES, Paris (FR); Simon CRISPEL, Sassenage (FR); Thomas FAYER, Sassenage (FR); Claire GIRARD, Les-Loges-En-Josas (FR)

(73) Assignee: L'Air Liquide, Societe Anonyme pour l'Etude et l’Exploitation des Procedes Georges Claude, Paris (FR)

(21) Appl. No.: 18/289,111

(22) PCT Filed: Mar. 31, 2022
(86) PCT No.: PCT/EP2022/058638

§ 371 Date: Oct. 31, 2023

(30) Foreign Application Priority Data
May 3, 2021 (FR) FR 2104614

(51) Int. Cl. F17C 9/02

(52) U.S. Cl. CPC F17C 9/02; F17C 2201/0109; F17C 2201/035; F17C 2201/054; F17C 2205/0326; F17C 2205/0332; F17C 2205/0338; F17C 2221/012; F17C 2223/0161; F17C 2223/033; F17C 2223/035; F17C 2223/041; F17C 2223/046; F17C 2227/0107; F17C 2227/0302; F17C 2250/0626; F17C 2250/0631; F17C 2265/063; F17C 2270/0171

(57) ABSTRACT

Disclosed is a device for storing and supplying cryogenic fluid, in particular an on-board device for storing and supplying liquefied hydrogen, which device comprises a cryogenic storage tank for storing liquefied fluid, a bleed-off circuit, and a system for pressurizing the tank comprising a pressurizing duct having two ends respectively connected to the upper and lower portions of the tank, a vaporizing heat exchanger and a set of one or more valves configured so as to allow liquid to be bled from the tank, to be heated in the heat exchanger and to be fed back into the tank; the system for pressurizing the tank being configured so as to bleed off a predetermined volume of fluid from the tank, to store and to isolate this volume in the vaporizing heat exchanger until the volume of fluid reaches predetermined temperature and/or pressure conditions prior to reinjecting the volume of fluid into the tank; the pressurizing duct comprising a member for limiting the flow rate and/or the pressure of the volume of reinjected fluid.

### CROSS REFERENCE TO RELATED APPLICATIONS

This application is a § 371 of International PCT Application PCT/EP2022/058637, filed Mar. 31, 2022, which claims the benefit of FR2104614, filed May 3, 2021, both of which are herein incorporated by reference in their entireties.

### FIELD OF THE INVENTION

The invention relates to a device for storing and supplying cryogenic fluid, to a vehicle comprising such a device and to a corresponding method.

### BACKGROUND OF THE INVENTION

The pressurization of cryogenic tanks, notably of liquefied hydrogen semi-trailers, is generally carried out by withdrawal of liquid, vaporization at a low point, and re-injection of the heated gas at a high point of the tank by the thermosiphon phenomenon.

This pressurization increases the internal energy of the system and leads to an increase in the saturation pressure (and in the temperature) of the liquid. This may be problematic in applications in which the client specifies a maximum delivery temperature for the fluid.

The temperature of the gas injected into the tank is an important optimization parameter. In order to limit the energy provided by a pressurization unit, it is advantageous for the gas to be injected at the highest possible temperature and for a high vertical thermal gradient in the tank (stratification) to be ensured so as to keep the liquid in the lower part at the coldest possible temperature.

### SUMMARY OF THE INVENTION

In certain embodiments, the invention relates more particularly to a device for storing and supplying cryogenic fluid, notably an on-board device for storing and supplying liquefied hydrogen, comprising a cryogenic tank for storing liquefied fluid, a withdrawal circuit, the device comprising a system for pressurizing the tank comprising a pressurization line having two ends respectively connected to the upper and lower parts of the tank, a vaporization heat exchanger and a set of valve(s) configured to allow liquid to be withdrawn from the tank, to be heated in the vaporization heat exchanger (4) and to be reintroduced into the tank.

An aim of the present invention is to overcome all or some of the drawbacks of the prior art outlined above.

In an effort to overcome the deficiencies of the prior art discussed, supra, the device according to the invention, which is otherwise in accordance with the generic definition thereof given in the above preamble, can include the system for pressurizing the tank is configured to withdraw a determined volume of fluid from the tank, store and isolate this volume in the vaporization heat exchanger until the volume of fluid reaches determined temperature and/or pressure conditions prior to re-injection of this volume of fluid into the tank, the pressurization line comprising a member for limiting the flow rate and/or the pressure of the re-injected volume of fluid.

Furthermore, embodiments of the invention may comprise one or more of the following features:
the set of valve(s) of the pressurization line comprises two isolation valves disposed on either side of the vaporization heat exchanger,
the element for limiting the flow rate and/or the pressure is disposed in parallel with the isolation valve situated between the vaporization heat exchanger and the upper end of the tank,
the element for limiting the flow rate and/or the pressure comprises a valve for regulating pressure to a determined level that is fixed or adjustable,
the element for limiting the flow rate and/or the pressure is constituted by one of the two isolation valves and/or a valve separate from the two isolation valves,
the pressurization line comprises a buffer storage reservoir that communicates with an outlet of the heat exchanger and that is configured to accommodate part of the volume of fluid,
the buffer storage reservoir is attached, for the one part, upstream of the isolation valve situated between the vaporization heat exchanger and the upper end of the tank, and, for the other part, downstream of the vaporization heat exchanger,
the pressurization line comprises a pressure-sensitive safety valve having a first end communicating with an outlet of the vaporization heat exchanger and a second, discharge end connected to a discharge zone such as the atmosphere or the tank,
the pressurization line comprises two vaporization heat exchangers disposed in parallel,
the device comprises a programmable electronic controller configured to control all or part of the set of valves and possibly the element for limiting the flow rate and/or the pressure, for example as a function of the pressure in the tank.

The invention may also relate to a vehicle, notably a truck, transporting a device as claimed in any one of the features above or below.

The invention may also relate to a method for regulating the pressure in a cryogenic tank of a device for storing and supplying cryogenic fluid or of such a vehicle, comprising a step of withdrawing a determined volume of fluid from the tank, a step of storing and of isolating this volume in the vaporization heat exchanger and, when the volume of fluid reaches, by spontaneous heating, a predetermined temperature and/or a predetermined pressure, a step of re-injecting this volume of fluid into the tank.

The invention may also relate to any alternative device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows a schematic and partial view in section illustrating a first example of the structure and operation of a device according to the invention,

FIG. 2 shows a schematic and partial view in section illustrating a vehicle provided with a second example of the structure and operation of a device according the invention,

FIG. 3 shows a schematic and partial view in section illustrating a third example of the structure and operation of a device according to the invention.

### DETAILED DESCRIPTION OF THE INVENTION

The illustrated device 1 for storing and supplying cryogenic fluid may be an on-board device for storing and supplying liquefied hydrogen.

The device 1 comprises a cryogenic tank 2 for storing liquefied fluid (for example a vacuum-insulated double-walled tank) and a withdrawal circuit 10. In the schematic example shown, the withdrawal circuit comprises a line for withdrawing liquid, but, of course, in a variant or in combination, a line for withdrawing gas may be envisaged. The same applies for the filling (same circuit as for the withdrawal or separate circuit).

The device 1 further comprises a system for pressurizing the tank 2, said system being provided with a pressurization line 3 having two ends respectively connected to the upper and lower parts of the tank 2. This pressurization line 3 comprises a vaporization heat exchanger 4 and a set of valve(s) 5, 6 configured to allow liquid to be withdrawn from the tank 2, to be heated in the vaporization heat exchanger 4 and to be reintroduced into the tank 2.

According to one advantageous particular feature, instead of heating via thermosiphon-type circulation, the system for pressurizing the tank 2 is configured to withdraw a determined volume of fluid from the tank 2, store and isolate this volume in the vaporization heat exchanger 4 until the volume of fluid reaches determined temperature and/or pressure conditions prior to re-injection of this volume of fluid into the tank 2. In addition, the pressurization line 3 comprises an element 7 for limiting the flow rate and/or the pressure of the re-injected volume of fluid.

For example, the captured fluid is re-injected into the tank 2 when its pressure has increased by 10 bar with respect to its initial conditions and/or when its pressure level reaches 25 bar and/or when the temperature has been increased by 50 degrees and/or when its temperature reaches 100 degrees kelvin.

That is to say that the pressurization system ensures a thermal compression of the fluid in the vaporization heat exchanger 4 so as to pressurize the tank 2 while limiting the input of energy.

The heated fluid may be injected into the gas blanket of the tank 2 via a nozzle limiting the temperature de-stratification of the fluid in the tank.

This makes it possible to maximize the pressurization of the tank 2 while limiting the input of energy therein.

This enables a better result than the known solutions which only vaporize the fluid and do not heat the re-injected cold fluid (in the known systems, a large quantity of fluid has to be vaporized in order to pressurize the tank 2).

The set of valve(s) 5, 6 of the pressurization line 3 may, to this end, comprise two isolation valves disposed on either side of the vaporization heat exchanger 4.

This auto-pressurization may be carried out by filling the vaporization heat exchanger 4 with liquid by opening the two corresponding valves 5, 6 and then closing them. Once the exchanger 4 (or the liquid that it contains) has reached a predetermined temperature (for example typically less than 30-40 K), the heated fluid will cause the pressure in the heat exchanger 4 to rise. When this pressure reaches a target value (which may be predetermined by calculation or by adjustment), the fluid can be re-injected into the tank 2.

The element 7 for limiting the flow rate and/or the pressure may be disposed in parallel with the isolation valve 6 situated between the vaporization heat exchanger 4 and the upper end of the tank 2. In addition, this element 7 for limiting the flow rate and/or the pressure may comprise or be constituted by a valve for regulating pressure to a determined level that is fixed or adjustable. This regulating valve 7 may, for example, be configured to open (automatically, for example passively or in a controlled manner) when the pressure in the vaporization exchanger 4 reaches the target value. This regulating valve 7 will then send the hot fluid to the tank 2.

The isolation valve 6 may, where appropriate, also open or be controlled.

The pressurization line 3 preferably comprises a pressure-sensitive safety valve 8 having a first end communicating with at least one from among: the upper end of the tank 2, an outlet of the vaporization heat exchanger 4 and a second, discharge end connected to a discharge zone such as the atmosphere around the device 1 or the gas blanket of the tank 2.

This valve protects the system from an overpressure that may damage the vaporization heat exchanger 4.

As illustrated in the example of [FIG. 2], the device 1 may be fitted on board a vehicle, notably a semi-trailer.

As also illustrated, an additional buffer storage reservoir 18 may be provided in the line 3. This storage reservoir forms a reduced volume capacity with respect to the volume of the tank 2 and may communicate with an outlet of the heat exchanger 4. This storage reservoir is configured to accommodate part of the volume of fluid which is captured (in order to increase this volume beyond the volume of the single heat exchanger 4).

For example, the buffer storage reservoir 18 is attached upstream of the isolation valve 6 situated between the vaporization heat exchanger 4 and the upper end of the tank 2. This therefore makes it possible to increase the available pressurized gas volume.

It should be noted that, in a variant or in combination, it is possible to envisage a device with two (or more) vaporization heat exchangers 4 (for example two exchangers with equivalent power or volume, for example two times less powerful respectively than in the variant with a single vaporization heat exchanger 4). This may allow a sequential usage of the two heat exchangers 4 in parallel and thus an increase in the frequency of the depressurization cycles to the tank. This may also improve the modularity of the pressurization system, for example by using one of the two exchangers for pressurization operations of a first level and the two exchangers simultaneously for higher pressurization operations (notably when the liquid level is relatively low in the tank 2). This variant also makes it possible to smooth the flow rates for re-injection of hot fluid. Specifically, a high flow rate of hot fluid may disrupt the temperature stratification of the gas blanket of the tank 2.

All or part of the set of valves and possibly the element 7 for limiting the flow rate and/or the pressure may be controlled by a programmable electronic controller 9 that comprises a microprocessor and that is configured for this purpose.

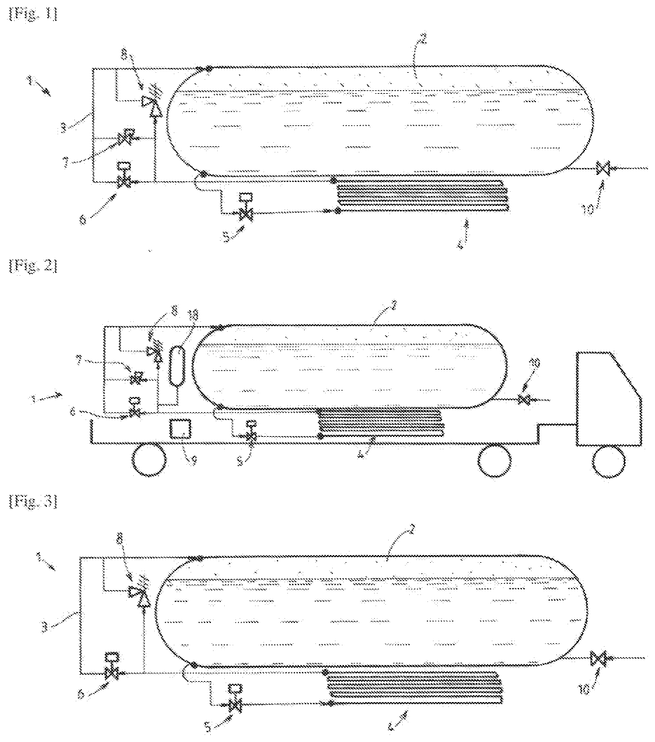

It should be noted that in one possible embodiment variant, the illustrated element 7 for limiting flow rate or pressure may be constituted by the isolation valve 6 interposed between the outlet of the vaporization heat exchanger 4 and the upper part of the tank 2. For example, this valve may be of the progressive opening type and its opening may be controlled as a function of the pressure in the vaporization heat exchanger 4. In this case, as illustrated in [FIG. 3], the additional separate element 7 for limiting flow rate shown in [FIG. 1] and [FIG. 2] can be omitted.

The invention, while being simple and inexpensive in structure, enables effective pressurization and optimizes the use of the pressurizing heater.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-11. (canceled)

12. A device for storing and supplying cryogenic fluid, the device comprising:
a cryogenic tank configured to store liquefied fluid;
a withdrawal circuit;
a pressurizing system configured to pressurize the cryogenic tank, the pressurizing system comprising:
a pressurization line having two ends respectively connected to the upper and lower parts of the tank,
a vaporization heat exchanger and
a set of valve(s) configured to allow liquid to be withdrawn from the tank, to be heated in the vaporization heat exchanger and to be reintroduced into the tank,
the pressurizing system being further configured to withdraw a determined volume of fluid from the tank, store and isolate said determined volume of fluid in the vaporization heat exchanger until the determined volume of fluid reaches determined temperature and/or pressure conditions prior to re-injection of this volume of fluid into the tank, and
wherein the pressurization line comprises an element configured to limit the flow rate and/or the pressure of the re-injected volume of fluid,
wherein the pressurization line comprises a buffer storage reservoir that communicates with an outlet of the heat exchanger and the pressurization line is configured to accommodate part of the volume of fluid.

13. The device as claimed in claim 12, wherein the buffer storage reservoir is attached, for the one part, upstream of the isolation valve situated between the vaporization heat exchanger and the upper end of the tank, and, for the other part, downstream of the vaporization heat exchanger.

14. The device as claimed in claim 12, wherein the set of valve(s) of the pressurization line comprises two isolation valves disposed on either side of the vaporization heat exchanger.

15. The device as claimed in claim 14, wherein the element for limiting the flow rate and/or the pressure is disposed in parallel with the isolation valve situated between the vaporization heat exchanger and the upper end of the tank.

16. The device as claimed in claim 14, wherein the element for limiting the flow rate and/or the pressure is constituted by one of the two isolation valves and/or a valve separate from the two isolation valves.

17. The device as claimed in claim 12, wherein the element for limiting the flow rate and/or the pressure comprises a valve for regulating pressure to a determined level that is fixed or adjustable.

18. The device as claimed in claim Error! Reference source not found., wherein the pressurization line comprises a pressure-sensitive safety valve having a first end communicating with an outlet of the vaporization heat exchanger and a second, discharge end connected to a discharge zone such as the atmosphere or the tank.

19. The device as claimed in claim Error! Reference source not found., wherein the pressurization line comprises two vaporization heat exchangers disposed in parallel.

20. The device as claimed in claim Error! Reference source not found., further comprising a programmable electronic controller configured to control all or part of the set of valves and possibly the element for limiting the flow rate and/or the pressure, for example as a function of the pressure in the tank.

21. A vehicle, notably a truck, transporting a device as claimed in claim Error! Reference source not found.

22. The vehicle as claimed in claim Error! Reference source not found., wherein the vehicle is a truck.

23. A method for regulating the pressure in a cryogenic tank of a device for storing and supplying cryogenic fluid in accordance with claim Error! Reference source not found., the method comprising a step of withdrawing a determined volume of fluid from the tank, a step of storing and of isolating this volume in the vaporization heat exchanger and, when the volume of fluid reaches, by spontaneous heating, a predetermined temperature and/or a predetermined pressure, a step of re-injecting this volume of fluid into the tank.

24. The method as claimed in claim Error! Reference source not found., wherein the device for storing and supplying cryogenic fluid is disposed on a vehicle.
